(19) United States
(12) Patent Application Publication
(10) Pub. No.: US 2021/0162948 A1
(43) Pub. Date: Jun. 3, 2021

(54) SHARING SYSTEM

(71) Applicant: KABUSHIKI KAISHA TOKAI RIKA DENKI SEISAKUSHO, Aichi (JP)

(72) Inventors: Masahiro ARAKAWA, Aichi (JP); Masahiko OYA, Aichi (JP); Yuichi INAMI, Aichi (JP); Tomohiro TSUCHIYA, Aichi (JP)

(73) Assignee: KABUSHIKI KAISHA TOKAI RIKA DENKI SEISAKUSHO, Aichi (JP)

(21) Appl. No.: 17/047,194

(22) PCT Filed: Apr. 18, 2019
(86) PCT No.: PCT/JP2019/016643

§ 371 Date: Oct. 13, 2020

(30) Foreign Application Priority Data
Apr. 20, 2018 (JP) 2018-081577

(51) Int. Cl. B60R 25/24; G08C 17/02

(52) U.S. Cl. CPC B60R 25/24; G08C 2201/94; G08C 17/02

(57) ABSTRACT

A sharing system includes a sharing device arranged in a shared subject. The sharing system further includes portable terminals including a main terminal and a further terminal, each obtaining key information required to use the shared subject and configured to operate the shared subject when authenticated through communication with the sharing device. The sharing system further includes a connection control unit configured to switch communication connection between the main terminal and the sharing device to manual connection when operation privilege is granted from the main terminal to the further terminal.

### TECHNICAL FIELD

The present invention relates to a sharing system that allows a shared subject to be used by a number of persons.

### BACKGROUND ART

A known example of a sharing system in which the same shared subject is shared by a number of persons is a car sharing system in which the same vehicle (shared vehicle) is used by a number of persons (for example, refer to Patent Documents 1 and 2). In this type of car sharing system, for example, use of the car sharing is registered in advance. For example, after reserving a vehicle with a portable terminal (high-performance mobile phone etc.), the vehicle can be used during a reserved period.

### PRIOR ART DOCUMENTS

### Patent Documents

Patent Document 1: Japanese Laid-Open Patent Publication No. 2016-115077

Patent Document 2: Japanese Laid-Open Patent Publication No. 2016-71834

### SUMMARY OF THE INVENTION

### Problems that the Invention is to Solve

When a number of persons use the same vehicle, if only one portable terminal is given permission to use the vehicle, the other users will not be able to use the vehicle. This is inconvenient to the other users. Thus, privilege to use the same vehicle may be given to users other than the person who made the reservation. However, in this case, for example, if the vehicle door is locked with one portable terminal while another portable terminal is left and forgotten in the vehicle, the other portable terminal may be “left behind” in the vehicle with the vehicle door locked.

The objective of the present invention is to provide a sharing system that restricts communication unintended by a user between a portable terminal and a sharing system.

### Means for Solving the Problem

A sharing system in accordance with one embodiment includes a sharing device, portable terminals, and a connection control unit. The sharing device is arranged in a shared subject. The portable terminals include a main terminal and a further terminal. Each of the portable terminals obtains key information required to use the shared subject and is configured to operate the shared subject when authenticated through communication with the sharing device. The connection control unit is configured to switch communication connection between the main terminal and the sharing device to manual connection when operation privilege is granted from the main terminal to the further terminal.

With the present configuration, when operation privilege of the shared subject is granted from the main terminal to the further terminal, the connection control unit is configured to switch the communication connection between the main terminal and the sharing device to the manual connection which requires a user to perform a manual operation of the main terminal to establish communication. This restricts communication unintended by the user between the main terminal and the sharing device.

In the sharing system, it is preferred that the operation privilege be the key information used for authentication performed with a corresponding one of the portable terminals and the sharing device. Preferably, the key information is a one-time code that can be used only once or only within a fixed time period. This configuration avoids a situation in which the shared subject is operated through unauthorized use of the key information. This is advantageous for improving the security.

In the sharing system, it is preferred that the sharing system include an operation privilege granting unit that sets the further terminal in a group that is same as the main terminal and grants the operation privilege of the shared subject to the further terminal. Preferably, the connection control unit is configured to switch communication connection between the main terminal and the sharing device to the manual connection when the operation privilege is granted to the further terminal in the same group as the main terminal. This configuration allows operation privilege to be granted only to the further terminal of which group has been set. This is advantageous for improving the security of granting of operation privilege.

In the sharing system, it is preferred that upon granting of the operation privilege from the main terminal to the further terminal, the connection control unit stop automatic connection that automatically connects the main terminal to the sharing device and switch communication connection between the main terminal and the sharing device to the manual connection. With this configuration, the automatic connection is forcibly stopped. This is further effective in restricting communication unintended by a user.

Preferably, the sharing system includes a parameter detector configured to detect a parameter that varies in accordance with a positional change of the main terminal. It is preferred that if operation privilege is granted from the main terminal to the further terminal when the connection control unit determines that a positional change of the main terminal is not occurring based on a detection signal of the parameter detector, the connection control unit forcibly interrupt connection between the main terminal and the sharing device and switch the communication connection to the manual connection. This configuration allows to the communication between the main terminal and the sharing device to be forcibly interrupted by appropriately determining that the main terminal is not in use.

### Effects of the Invention

The present invention restricts communication unintended by a user between the portable terminal and the sharing device.

### BRIEF DESCRIPTION OF THE DRAWINGS

FIG. 1 is a schematic diagram of a sharing system in accordance with a first embodiment.

FIG. 2 is a diagram illustrating a procedure of user authentication.

FIG. 3 is a diagram illustrating a procedure of a vehicle operation performed with a portable terminal.

FIG. 4 is a diagram illustrating a procedure of granting of an operation privilege to a further terminal.

FIG. 5 is a flowchart illustrating actuation of an automatic connection control.

FIG. 6 is a flowchart illustrating actuation of a manual connection control.

FIG. 7 is a flowchart illustrating a procedure of returning of the operation privilege.

FIG. 8 is a flowchart illustrating actuation of an automatic connection control in accordance with a second embodiment.

FIG. 9 is a flowchart illustrating actuation of a manual connection control.

### EMBODIMENTS OF THE INVENTION

### First Embodiment

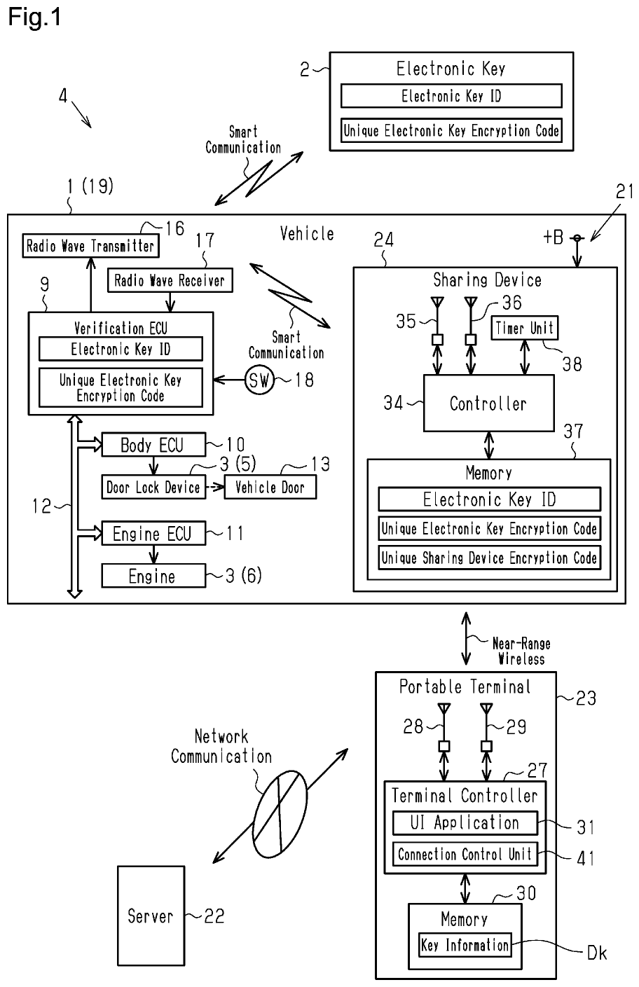

One embodiment of a sharing system will now be described with reference to FIGS. 1 to 7.

As shown in FIG. 1, a vehicle 1 includes an electronic key system 4 in which ID verification is performed through wireless communication established with an electronic key 2 to execute or permit operations of an in-vehicle device 3. The electronic key system 4 is a key-operation-free system in which ID verification (smart verification) is performed through short-range wireless communication when communication is established with the vehicle 1. In the key-operation-free system, ID verification is automatically performed without directly operating the electronic key 2. For example, the in-vehicle device 3 includes a door lock device 5 and an engine 6.

The vehicle 1 includes a verification electronic control unit (ECU) 9, a body ECU 10, and an engine ECU 11. The verification ECU 9 performs ID verification, the body ECU 10 manages a power source of in-vehicle electric components, and the engine ECU 11 controls the engine 6. The ECUs 9 to 11 are electrically connected by communication lines 12 arranged inside the vehicle 1. The communication lines 12 are, for example, a Controller Area Network (CAN) and/or a Local Interconnect Network (LIN). The verification ECU 9 and the electronic key 2 each have a memory (not shown) that stores an electronic key ID of the electronic key 2 registered to the vehicle 1 and a unique electronic key encryption code that is used for ID verification. The body ECU 10 controls the door lock device 5 that locks and unlocks a vehicle door 13.

The vehicle 1 includes a radio wave transmitter 16 that transmits radio waves and a radio wave receiver 17 that receives radio waves. The radio wave transmitter 16 includes, for example, an exterior transmitter (not shown) that transmits radio waves outside the vehicle and an interior transmitter (not shown) that transmits radio waves inside the vehicle. The radio wave transmitter 16 transmits radio waves on a low frequency (LF) band. The radio wave receiver 17 receives radio wave receivers on an ultra high frequency (UHF) band. The electronic key system 4 establishes communication with the electronic key 2 through LF-UHF bidirectional communication (smart communication).

When a wake signal that activates the electronic key 2 is transmitted from the radio wave transmitter 16 on LF radio waves, if the electronic key 2 enters a communication area of the wake signal and receives the wake signal, the electronic key 2 is activated from a standby mode to perform ID verification (smart verification) through communication (smart communication) established with the verification ECU 9. The smart verification includes, for example, electronic key ID verification that checks the authenticity of an electronic key ID or challenge-response authentication that uses the encryption code (in present example, unique electronic key encryption code). When the verification ECU 9 confirms that ID verification of the electronic key 2 outside the vehicle (exterior smart verification) has been accomplished, the verification ECU 9 permits or executes locking or unlocking of the vehicle door 13 with the body ECU 10.

When the verification ECU 9 confirms that ID verification of the electronic key 2 inside the vehicle (interior smart verification) has been accomplished, the verification ECU 9 permits a power source transition operation by an engine switch 18. Thus, for example, when the engine switch 18 is operated while a brake pedal is depressed, the engine 6 will be started.

The vehicle 1 includes a sharing system 21 for sharing the same vehicle 1 (shared subject 19) with a number of persons. In the sharing system 21 of the present example, encrypted key information Dk is obtained from an external facility (server 22 in present example) and registered to a portable terminal 23. Further, the key information Dk is authenticated with the portable terminal 23 and a sharing device 24 that is arranged in the vehicle 1. The authentication result is one condition for determining whether to allow the vehicle 1 to be operated. Preferably, the key information Dk is, for example, a one-time code (one-time password) that can be used only once or only within a fixed time period.

The portable terminal 23 includes a terminal controller 27, a network communication module 28, a near-range wireless module 29, and a memory 30. The terminal controller 27 controls actuation of the portable terminal 23. The network communication module 28 performs network communication. The near-range wireless module 29 performs near-range wireless communication. Data is rewritable to the memory 30. When the portable terminal 23 obtains the key information Dk through network communication from the server 22, the portable terminal 23 stores the key information Dk in the memory 30. Preferably, the near-range wireless communication is, for example, Bluetooth® communication.

The portable terminal 23 includes a user interface application 31 that manages actuation of the sharing system 21. For example, the user interface application 31 is downloaded from the server 22 and installed in the terminal controller 27. The terminal controller 27 executes the user interface application 31 to perform various types of operations such as a reservation of the vehicle 1, user authentication, a vehicle operation, grant of operation privilege, and return of operation privilege.

The sharing device 24 is independent from the hardware of the electronic key system 4 of the vehicle 1 and installed in the vehicle 1 separately from the electronic key system 4. The sharing device 24 serves as, for example, an electronic key that is enabled only during the reserved period of the vehicle 1. Power is supplied to the sharing device 24 from a battery +B of the vehicle 1.

The sharing device 24 includes a controller 34, a smart communication block 35, a near-range wireless module 36, a memory 37, and a timer unit 38. The controller 34 controls actuation of the sharing device 24. The smart communication block 35 performs smart communication. The near-range wireless module 36 performs near-range wireless communication. Data is rewritable to the memory 37. The timer unit 38 manages the date and the time. When the controller 34 receives the key information Dk through near-range wireless communication from the portable terminal 23, the controller 34 checks whether the key information Dk can be decrypted correctly with the encryption code (in present example, unique sharing device encryption code) in the memory 37 to determine the authenticity of the portable terminal 23. The timer unit 38 is, for example, formed by a software timer. The sharing device 24 includes a sharing device ID that is registered and linked to the vehicle ID (vehicle number) so that the sharing device 24 has a one-to-one relationship with the vehicle 1.

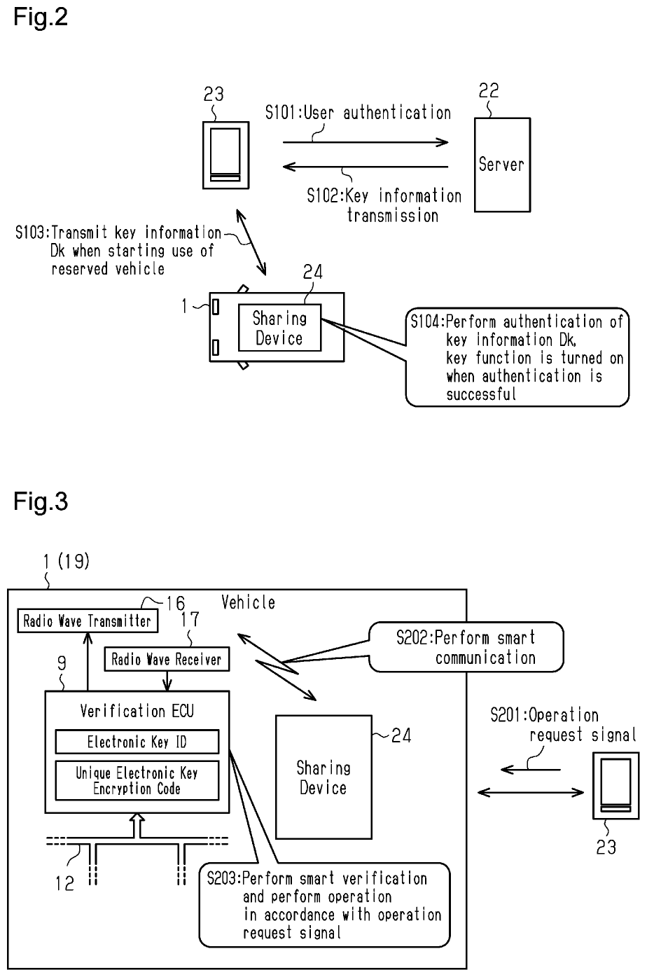

As shown in FIG. 2, in step 101, when reserving the vehicle 1 with the portable terminal 23, the portable terminal 23 performs user authentication through network communication with the server 22. In the user authentication of the present example, for example, user login (authentication of user ID and password) and vehicle reservation are performed. In the vehicle reservation, for example, the vehicle that will be used, the date and time, and the like are input. The user ID and the password input to the portable terminal 23 are transmitted through network communication to the server 22. When the server 22 receives the user ID and the password from the portable terminal 23, the server 22 authenticates the received user ID and password. When the authentication is successful, the server 22 continues the process. When the authentication is unsuccessful, the server 22 forcibly ends the process.

When the user is authenticated, the server 22 generates the key information Dk and transmits the generated key information DK to the portable terminal 23 in step 102. In the present example, the server 22 generates the key information Dk, for example, using the encryption code (e.g. unique sharing device encryption code) of the sharing device 24 that is installed in the reserved vehicle. The key information Dk in the present example is, for example, ciphertext generated by encrypting cleartext that includes data elements such as “reserved date and time”, “terminal ID”, “user authentication code”, and “group ID” with cipher (encryption algorithm) using a predetermined encryption code (e.g., unique sharing device encryption code). The group ID is an ID unique to each group. The terminal ID is an ID unique to the portable terminal 23. The user authentication code is, for example, one type of a code that is used in encrypted communication established between the portable terminal 23 and the sharing device 24 when operating the vehicle 1 with the portable terminal 23.

In step 103, when starting use of the reserved vehicle, the portable terminal 23 transmits the registered key information Dk through near-range wireless communication. The key information Dk is, for example, transmitted to the sharing device 24 using Bluetooth Low Energy (BLE).

In step 104, the sharing device 24 receives the key information Dk from the portable terminal 23 and authenticates the key information Dk. In the present example, the sharing device 24 decrypts the key information Dk with the encryption code (e.g., unique sharing device encryption code) and checks whether the decryption is successful. When the key information Dk is decrypted, the key information Dk received from the portable terminal 23 is valid and thus the key information Dk is authenticated. When the key information Dk is authenticated, the sharing device 24 obtains “reserved date and time”, “terminal ID”, “user authentication code”, and “group ID” included in the key information Dk.

When the key information Dk is authenticated, the sharing device 24 is shifted to an “authentication completion state” of the key information Dk and the function that actuates the sharing device 24 as the electronic key 2 is enabled (key function of sharing device 24 turned ON). Thus, the sharing device 24 performs smart communication (smart function) with the electronic key system 4. Further, when the key information Dk is authenticated, the sharing device 24 stores the key information Dk and the user authentication code in the memory 37. When the key information Dk is not authenticated, the sharing device 24 determines that the authentication was unsuccessful since the key information Dk was invalid and interrupts the BLE communication.

When the key information Dk is authenticated, the sharing device 24 performs near-range wireless communication to notify the portable terminal 23 of the user authentication code obtained through the authentication. The portable terminal 23 receives the user authentication code from the sharing device 24 and registers the user authentication code to the memory 30. In this manner, the user authentication code is registered to both of the portable terminal 23 and the sharing device 24.

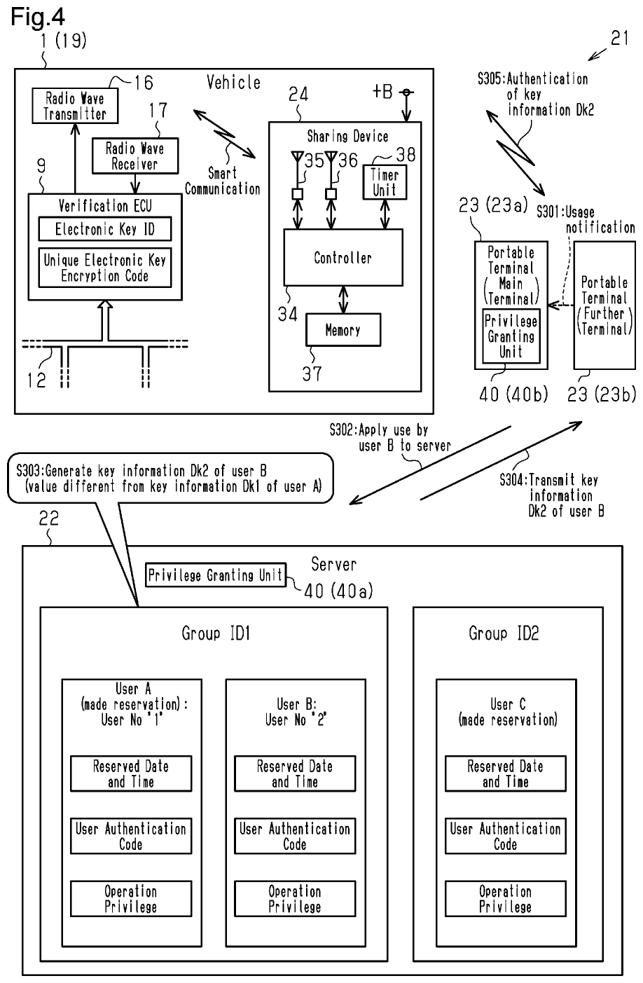

As shown in FIG. 3, in step 201, when an operation request button (button displayed on screen) of the portable terminal 23 is operated after the portable terminal 23 has been shifted to the authentication completion state, the portable terminal 23 transmits an operation request signal corresponding to the button through near-range wireless communication to the sharing device 24. Examples of the operation request button include an unlocking request button that is operated to unlock the vehicle door 13, a locking request button that is operated to lock the vehicle door 13, an engine start request button that is operated to permit the vehicle 1 to start the engine 6, and the like. The operation request signal is a signal including a command corresponding to the operation request button that is operated. The operation request signal is, for example, encrypted by the user authentication code and transmitted.

In step 202, when the sharing device 24 receives the operation request signal from the portable terminal 23, the sharing device 24 establishes smart communication with the verification ECU 9 to notify the verification ECU 9 of the operation request signal received from the portable terminal 23. In the present example, the sharing device 24 performs smart verification using the electronic key ID and the encryption code, which are registered to the sharing device 24. During the verification, the sharing device 24 notifies the verification ECU 9 of the operation request signal received from the portable terminal 23.

In step 203, when the verification ECU 9 confirms that smart verification with the sharing device 24 was successful, the verification ECU 9 performs an operation corresponding to the operation request signal of the notification from the sharing device 24. This locks or unlocks the vehicle door 13 or permits engine starting.

As shown in FIG. 4, the sharing system 21 includes a privilege granting unit 40 that grants a privilege to operate the vehicle 1 from a main terminal 23a to a further terminal 23b. The main terminal 23a is a portable terminal used by the person who reserved the vehicle 1. The further terminal 23b is a portable terminal carried by a user (for example, family member or the like) other than the person who made the reservation. The privilege granting unit 40 of the present example includes a first privilege granting unit 40a arranged in the server 22 and a second privilege granting unit 40b arranged in the main terminal 23a. In the present example, the owner of the main terminal 23a, or the person who reserved the vehicle 1, is referred to as “user A”. Further, the owner of the further terminal 23b, or a person who is in the same group as user A and borrows the vehicle 1 from user A, is referred to as “user B”. The group of user A is “group ID1”, and the user number of user A in the group is No“1”.

When user B uses the vehicle 1, user B notifies user A of the use of the vehicle 1 in step S301. Preferably, the use is notified when, for example, user B operates the further terminal 23b to notify the main terminal 23a of user A of the desire to use the vehicle 1 through network communication or near-range wireless communication.

In step 302, user A applies for the use of the vehicle by user B to the server 22 by issuing an operation privilege that permits the use of the vehicle 1 by user B. In the present example, user A, for example, operates his or her main terminal 23a to notify the server 22 of the notification of use received from user B. In this manner, the server 22 acknowledges that user B belongs to the same group as user A and assigns “group ID1” to user B. When applying for the usage, the reserved date and time and the like desired by user B are notified to the server 22.

In step 303, after the server 22 sets user B to the same group (group ID1) as user A and sets the number of user B in the group (user No“2”), the server 22 generates key information (hereafter, second key information Dk2) and issues the key information to user B. In this case, the server 22 generates the key information (second key information Dk2) having a value that differs from the key information (first key information Dk1) issued for user A. Preferably, the second key information Dk2 is, for example, ciphertext generated by encrypting cleartext that includes data elements such as “group ID” (in present example, group ID1), “reserved date and time”, “terminal ID”, “user authentication code” (user authentication code differing from that included in first key information Dk1 issued for user A), “operation privilege information” with cipher (encryption algorithm) using a predetermined encryption code (e.g., unique sharing device encryption code).

In step 304, the server 22 transmits the second key information Dk2 issued for user B to the further terminal 23b of user B.

In step 305, when near-range wireless communication is established between the further terminal 23b and the sharing device 24 of the vehicle 1, the further terminal 23b that has obtained the second key information Dk2 authenticates the second key information Dk2. The authentication of the second key information Dk2 is performed in the same manner as in steps 103 and 104 described above and thus will not be described in detail. When the second key information Dk2 is authenticated, the key-function of the sharing device 24 is turned ON and the operation privilege of the vehicle 1 is granted to the further terminal 23b. In this manner, the granting of the operation privilege in the present example corresponds to assignment (registration) of the key information Dk. This allows the vehicle 1 to be used with the further terminal 23b.

When user C, who belongs to a group different from users A and B, uses his or her portable terminal 23 to make a reservation for the vehicle 1 with the server 22, the server 22 recognizes that user C belongs to a different group from users A and B and assigns a group ID of “group 1D2” to user C. Then, the server 22 generates different key information Dk for user C and issues the key information Dk to the portable terminal 23 of user C. The portable terminal 23 of user C authenticates the key information Dk, which is obtained from the server 22, with the sharing device 24. When the key information Dk is authenticated, various types of operations of the vehicle 1 will be allowed. When user C is allowed to use the vehicle 1, users A and B having the group ID that is different from user C will not be able to use the vehicle 1.

As shown in FIG. 1, the sharing system 21 includes a connection control unit 41 that switches communication connection modes between the main terminal 23a and the sharing device 24. The connection control unit 41 is arranged in the terminal controller 27 of the portable terminal 23 (main terminal 23a) and is functionally implemented, for example, when the terminal controller 27 executes the user interface application 31. The connection control unit 41 of the present example is configured to switch communication connection between the main terminal 23a and the sharing device 24 to manual connection when the operation privilege of the vehicle 1 is granted from the main terminal 23a to the further terminal 23b. In the first embodiment, upon granting of operation privilege to the further terminal 23b, the communication connection mode is switched to manual connection control.

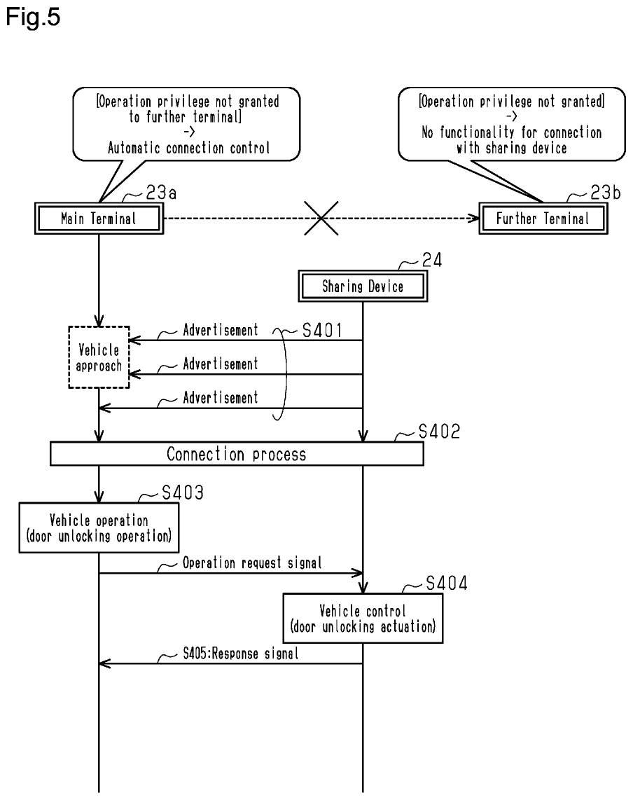

The operation and advantages of the sharing system 21 in the first embodiment will now be described with reference to FIGS. 5 to 7. FIG. 5 is a flowchart illustrating a procedure of a vehicle operation when operation privilege is not granted from the main terminal 23a to the further terminal 23b. When the operation privilege of the vehicle 1 is not granted from the main terminal 23a to the further terminal 23b, the connection control unit 41 sets the communication connection mode between the main terminal 23a and the sharing device 24 to “automatic connection control” in which communication is automatically established. In the case of Bluetooth® communication of the present example, the automatic connection control refers to a communication connection mode in which the main terminal 23a responds to an advertising packet (hereafter, “advertisement”) from a slave (i.e., sharing device 24) and automatically returns a connection request so that the main terminal 23a automatically establishes communication with the sharing device 24 without the need to operate the main terminal 23a.

As shown in FIG. 5, in step 401, the sharing device 24 periodically transmits the advertisement to check whether a connectable portable terminal 23 is present nearby.

In step 402, when the main terminal 23a approaches the sharing device 24 (vehicle 1) and receives the advertisement, the main terminal 23a performs a process for establishing Bluetooth® communication (BLE communication) connection with the sharing device 24. Specifically, when operation privilege is not granted from the main terminal 23a to the further terminal 23b, the communication connection mode between the main terminal 23a and the sharing device 24 is set to “automatic connection control” by the connection control unit 41. In this case, when receiving an advertisement from the sharing device 24, the main terminal 23a returns a connection request to the sharing device 24. This establishes communication connection between the main terminal 23a and the sharing device 24. If the connection process is completed but the main terminal 23a and the sharing device 24 have not been shifted to an “authentication completion state”, a process for shifting the main terminal 23a and the sharing device 24 to the authentication completion state will be performed.

In step 403, when a vehicle operation (operation of operation request button on main terminal 23a) is performed, the main terminal 23a transmits an operation request signal corresponding to the operation through near-range wireless communication to the sharing device 24. For example, when a door-unlocking operation is performed by pressing an unlocking request button on the main terminal 23a, an unlocking request signal is transmitted to the sharing device 24.

In step 404, when the sharing device 24 receives the operation request signal from the main terminal 23a, the sharing device 24 performs vehicle control in accordance with the received operation request signal. In this case, when the sharing device 24 receives the unlocking request signal as the operation request signal, the sharing device 24 unlocks the vehicle door 13 by actuating the electronic key system 4. When the sharing device 24 receives a locking request signal as the operation request signal, the vehicle door 13 will be locked. When the sharing device 24 receives an engine start request signal as the operation request signal, starting of the engine 6 will be permitted.

In step 405, when the vehicle control is completed, the sharing device 24 transmits a response signal notifying the completion through near-range wireless communication to the main terminal 23a. When the response signal is received, the main terminal 23a recognizes that the vehicle control has been completed. In this case, it is preferred that the main terminal 23a show the completed vehicle control (unlocking of vehicle door, locking of vehicle door, engine start permission) on a display or the like of the main terminal 23a.

Here, operation privilege is not granted from the main terminal 23a to the further terminal 23b. In this case, the further terminal 23b has no functionality for connection with the sharing device 24. Thus, the further terminal 23b cannot perform vehicle control (vehicle operation).

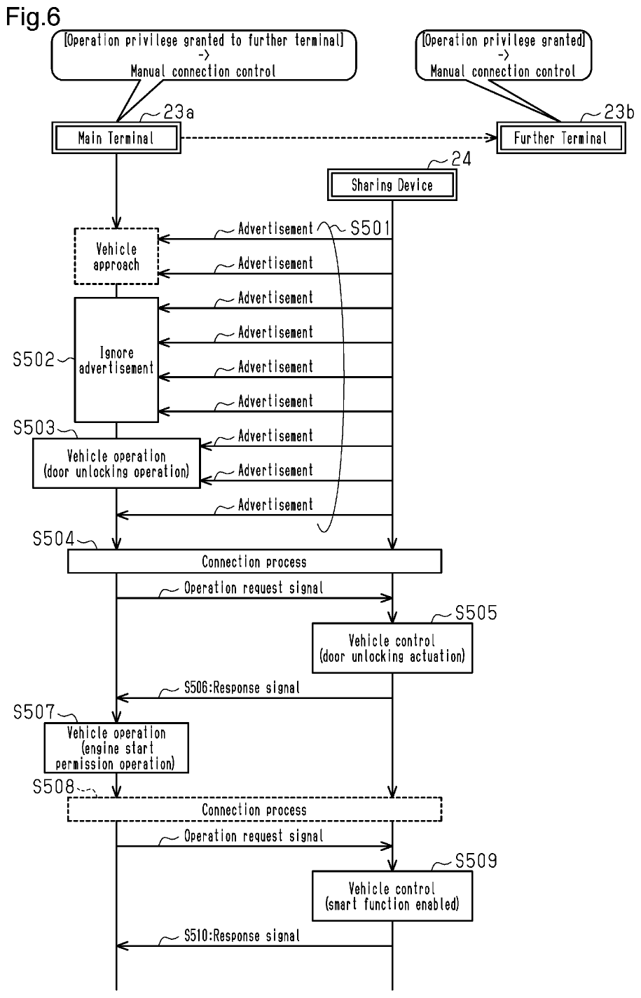

FIG. 6 is a flowchart illustrating a procedure of a vehicle operation when the operation privilege is granted from the main terminal 23a to the further terminal 23b. When operation privilege of the vehicle 1 is granted from the main terminal 23a to the further terminal 23b that belongs to the same group as the main terminal 23a, the connection control unit 41 sets the communication connection mode between the main terminal 23a and the sharing device 24 to “manual connection control” in which a manual operation is required to establish communication between the main terminal 23a and the sharing device 24. In the case of Bluetooth® communication of the present example, the manual connection control refers to a communication connection mode in which the main terminal 23a transmits a connection request to a slave (here, sharing device 24), for example, when a manual operation for Bluetooth® communication connection is performed with the main terminal 23a.

In step 501, the sharing device 24 periodically transmits an advertisement to check whether a connectable portable terminal 23 is present nearby.

In step 502, the main terminal 23a ignores the advertisements received from the sharing device 24 since the manual connection control has been set. In this case, the main terminal 23a does not transmit a connection request as a response to an advertisement and does not establish communication connection (Bluetooth® connection) with the sharing device 24.

In step 503, if a vehicle operation (operation of operation request button on main terminal 23a) is input when the main terminal 23a is in the state of “manual connection control”, the vehicle operation switches the main terminal 23a to a state permitting a connection process to be performed. In the present example, a tapping operation on the screen of the main terminal 23a corresponds to the manual operation of communication connection. This allows the main terminal 23a to perform a process for connecting with the sharing device 24.

In step 504, the main terminal 23a performs the connection process for Bluetooth® communication (BLE communication) at a time point at which the advertisement is received after the connection process is permitted. This establishes communication between the main terminal 23a and the sharing device 24. When the communication connection with the sharing device 24 is completed, the main terminal 23a transmits an operation request signal (here, unlocking request signal) corresponding to the vehicle operation (operation of operation request button on main terminal 23a) through near-range wireless communication to the sharing device 24.

In step 505, when the sharing device 24 receives the operation request signal from the main terminal 23a, the sharing device 24 performs vehicle control in accordance with the received operation request signal. In this case, when the sharing device 24 receives the unlocking request signal as the operation request signal, the sharing device 24 unlocks the vehicle door 13 by actuating the electronic key system 4.

In step 506, when the vehicle control is completed, the sharing device 24 transmits a response signal notifying the completion through near-range wireless communication to the main terminal 23a.

In step 507, when an engine start permission operation is input to the main terminal 23a as a vehicle operation, the main terminal 23a is switched to a state in which the connection process for the communication with the sharing device 24 is permitted. Thus, the connection process is performed when an advertisement is subsequently received to establish communication.

In step 508, when the main terminal 23a receives an advertisement from the sharing device 24 in a state in which communication establishment with the sharing device 24 is permitted, the main terminal 23a performs the connection process to establish Bluetooth® communication (BLE communication). Then, the main terminal 23a transmits an operation request signal (engine start permission request signal) in accordance with the vehicle operation (operation on main terminal 23a for engine start permission) through near-range wireless communication to the sharing device 24.

In step 509, when the sharing device 24 receives the operation request signal (engine start permission request) from the main terminal 23a, the sharing device 24 requests a permission to start the engine by actuating the electronic key system 4. This enables the smart function of the electronic key system 4. That is, a power source transition operation of the vehicle 1 by the engine switch 18 is permitted.

In step 510, when the vehicle control is completed (smart function enabled), the sharing device 24 transmits a response signal notifying the completion through near-range wireless communication to the main terminal 23a. The main terminal 23a displays the completion of the engine start permission operation on the screen or the like of the main terminal 23a. Therefore, the engine 6 will be started when the engine switch 18 is pressed while a brake pedal is being depressed.

Here, the operation privilege has been granted from the main terminal 23a to the further terminal 23b. In this case, the further terminal 23b has a functionality for connection with the sharing device 24. In the present example, the further terminal 23b, which has been granted operation privilege, establishes communication with the sharing device 24 through “manual connection control” in the same manner as the main terminal 23a. Thus, when a vehicle operation is performed with the further terminal 23b, a separate manual operation needs to be performed on the further terminal 23b to establish communication with the sharing device 24.

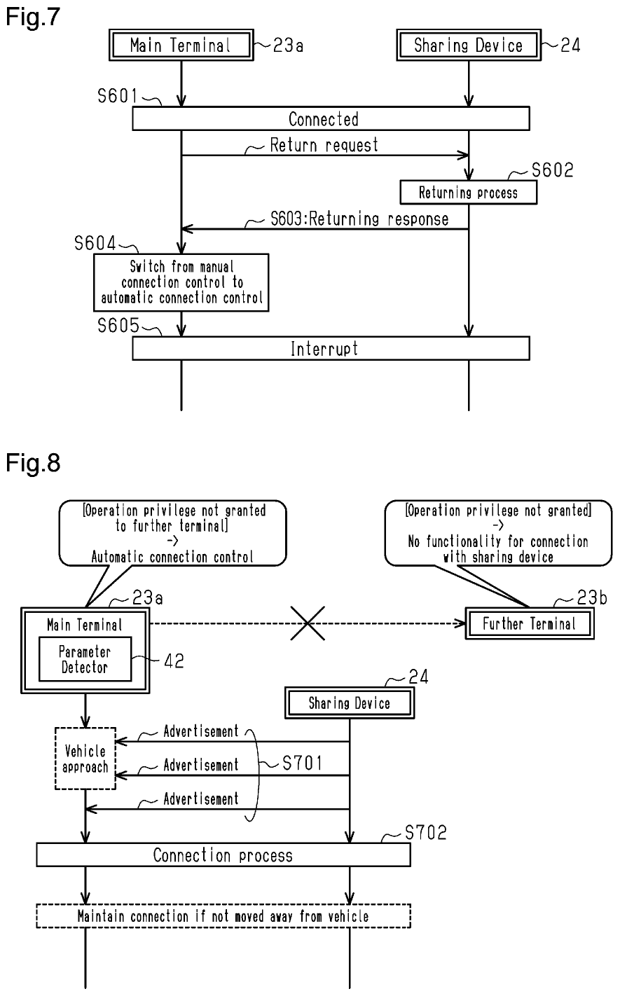

FIG. 7 is a flowchart illustrating a process of returning the operation privilege of the vehicle 1 that had been granted to the further terminal 23b. The operation privilege is returned through communication between the main terminal 23a of the person who made the reservation and the sharing device 24.

In step 601, when an operation privilege returning operation is performed with the main terminal 23a while communication is established with the sharing device 24, the main terminal 23a transmits a return request to the sharing device 24. Preferably, the operation privilege returning operation is performed by displaying an operation privilege returning button on the screen of the main terminal 23a and tapping the button.

P3P20190094US

In step 602, when the sharing device 24 receives the return request from the main terminal 23a, the sharing device 24 performs a returning process with the further terminal 23b, which is a returning subject. Preferably, the returning process is, for example, a process of deleting the second key information Dk2 (including user authentication code) held in the sharing device 24.

In step 603, when the returning process is completed, the sharing device 24 transmits a returning response notifying the completion to the main terminal 23a.

In step 604, when the main terminal 23a receives the returning response from the sharing device 24, the main terminal 23a switches the connection mode between the main terminal 23a and the sharing device 24 from the manual connection control to the automatic connection control. In other words, the connection control unit 41 switches the communication connection mode of the main terminal 23a back to the automatic connection control at a time point at which the operation privilege is returned from the further terminal 23b.

In step 605, after the communication connection mode of the main terminal 23a returns to automatic connection control, the main terminal 23a and the sharing device 24 interrupt the communication connection (BLE connection). This completes returning of the operation privilege.

In the present example, when operation privilege of the vehicle 1 is granted from the main terminal 23a to the further terminal 23b, the communication connection mode between the main terminal 23a and the sharing device 24 is switched to the manual connection control which requires the user to perform a manual operation of the main terminal 23a to establish communication. This restricts communication unintended by the user between the main terminal 23a and the sharing device 24.

The operation privilege is the key information Dk used for the authentication performed by the portable terminal 23 and the sharing device 24, and the key information Dk is a one-time code that can be used only once or only within a fixed time period. This avoids a situation in which the vehicle 1 is operated by unauthorized use of the key information Dk. This is advantageous for improving security.

When the operation privilege is granted to the further terminal 23b belonging to the same group as the main terminal 23a, the connection control unit 41 switches the communication between the main terminal 23a and the sharing device 24 to manual connection. This allows the operation privilege to be granted only to the further terminal 23b of which the group has been set. This is advantageous for improving security of granting of the operation privilege.

Particularly, in the first embodiment, upon granting of the operation privilege from the main terminal 23a to the further terminal 23b, the connection control unit 41 stops the automatic connection that automatically connects the main terminal 23a to the sharing device 24 and switches the communication connection to the manual connection. Thus, the automatic connection is forcibly stopped. This is further effective in restricting communication unintended by the user.

### Second Embodiment

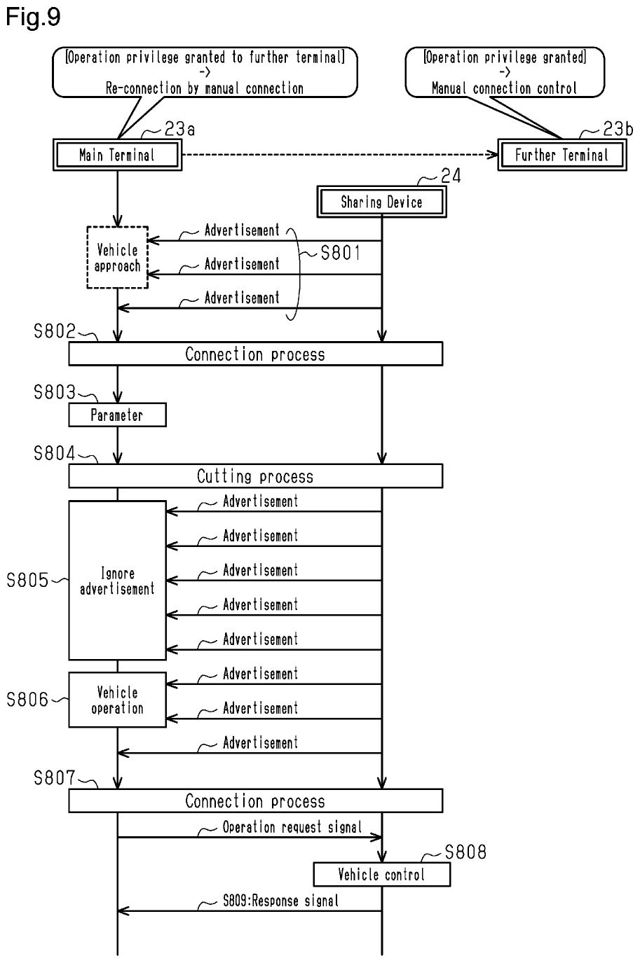

A second embodiment will now be described with reference to FIGS. 8 and 9. The second embodiment is an example in which a method for switching from the automatic connection control to the manual connection control is changed from that in the first embodiment. Therefore, parts that are the same as the first embodiment will not be described, and only differences from the first embodiment will be described in detail.

FIG. 8 is a flowchart illustrating a procedure taken to perform an actuation when operation privilege is not granted from the main terminal 23a to the further terminal 23b. As shown in FIG. 8, the main terminal 23a includes a parameter detector 42 configured to detect a parameter that varies in accordance with a positional change of the main terminal 23a. Preferably, the parameter in the present example is, for example, a received signal strength indicator (RSSI) of the radio waves the main terminal 23a receives from the sharing device 24 or an acceleration of the main terminal 23a. When the parameter is RSSI, the value of RSSI is obtained from an output of a received signal strength measurement unit arranged in the main terminal 23a. Further, when the parameter is acceleration, the value of acceleration is obtained from an output of an acceleration sensor arranged in the main terminal 23a.

When operation privilege of the vehicle 1 is not granted from the main terminal 23a to the further terminal 23b, the connection control unit 41 sets the communication connection mode between the main terminal 23a and the sharing device 24 (in present example, Bluetooth® communication connection) to “automatic connection control”.

When operation privilege is granted from the main terminal 23a to the further terminal 23b, the connection control unit 41 determines whether the main terminal 23a is in use based on a detection signal of the parameter detector 42. When the connection control unit 41 determines that a positional change of the main terminal 23a has not occurred, the connection control unit 41 forcibly interrupts connection between the main terminal 23a and the sharing device 24. In this case, the main terminal 23a and the sharing device 24 can be manually re-connected with the main terminal 23a.

In the case of FIG. 8, in step 701 and step 702, when the main terminal 23a receives an advertisement, which is periodically transmitted from the sharing device 24, the main terminal 23a performs the connection process in accordance with the procedure of the automatic connection control and automatically establishes connection with the sharing device 24. That is, when the main terminal 23a approaches the sharing device 24, communication is automatically established between the main terminal 23a and the sharing device 24. Then, the connection is maintained as long as the main terminal 23a stays close to the vehicle 1 (sharing device 24).

FIG. 9 is a flowchart illustrating a procedure of a vehicle operation when operation privilege is granted from the main terminal 23a to the further terminal 23b. When operation privilege of the vehicle 1 is granted from the main terminal 23a to the further terminal 23b, the connection control unit 41 is configured to switch the communication connection mode (Bluetooth® communication connection) between the main terminal 23a and the sharing device 24 to “manual connection control”. In the second embodiment, when operation privilege is granted to the further terminal 23b and a predetermined switching condition is satisfied, the communication connection mode is switched to manual connection control.

In the case of FIG. 9, in step 801 and step 802, when the main terminal 23a approaches the sharing device 24, the main terminal 23a automatically establishes communication in accordance with the actuation of the automatic connection control in the same manner as in steps 701 and 702 described above. Thus, communication is automatically established between the main terminal 23a and the sharing device 24.

In step 803, the main terminal 23a (connection control unit 41) determines whether a positional change of the main terminal 23a has occurred based on the detection signal of the parameter detector 42. Specifically, the main terminal 23a determines whether the main terminal 23a is carried by the user and a positional change is occurring as the user moves. In the present example, changes in the received signal strength (RSSI) and/or changes in acceleration are determined. When a positional change is occurring to the main terminal 23a, it is reasonable to determine that the main terminal 23a is being carried by the user. Further, when a positional change of the main terminal 23a is not occurring, there is a high probability that the main terminal 23a has been left and forgotten inside the vehicle.

In step 804, when the connection control unit 41 determines that a positional change of the main terminal 23a is occurring, the connection control unit 41 forcibly interrupts communication between the main terminal 23a and the sharing device 24 (Bluetooth® communication). Thus, the main terminal 23a and the sharing device 24 cannot communicate with each other.

In step 805, since communication (Bluetooth® communication) is interrupted, the main terminal 23a ignores the advertisements received from the sharing device 24. That is, the main terminal 23a does not transmit a connection request as a response to the advertisement and does not establish communication connection (Bluetooth® connection) with the sharing device 24.

In step 806, if vehicle operation (operation of operation request button on main terminal 23a) is performed when the communication has been interrupted, the vehicle operation switches the main terminal 23a to a state in which the connection process is permitted. That is, the communication is re-established by “manual connection”. The operation of the manual connection switches the main terminal 23a to a state permitting the process for connecting to the sharing device 24.

In step 807, the main terminal 23a performs the connection process for Bluetooth® communication (BLE communication) at a time point at which an advertisement is received after performance of the connection process has been permitted and establishes communication connection between the main terminal 23a and the sharing device 24. Then, the main terminal 23a transmits an operation request signal (unlocking request signal) in accordance with the vehicle operation (operation of operation request button on main terminal 23a) through near-range wireless communication to the sharing device 24.

In step 808, when the sharing device 24 receives the operation request signal from the main terminal 23a, the sharing device 24 performs vehicle control in accordance with the received operation request signal.

In step 809, when the vehicle control is completed, the sharing device 24 transmits a response signal notifying the completion through near-range wireless communication to the main terminal 23a.

In the present example, if operation privilege is granted from the main terminal 23a to the further terminal 23b when the connection control unit 41 determines that a positional change of the main terminal 23a has not been occurring based on the detection signal of the parameter detector 42, the connection control unit 41 forcibly interrupts the connection between the main terminal 23a and the sharing device 24 and switches the communication connection to manual connection. Thus, the communication between the main terminal 23a and the sharing device 24 is forcibly interrupted by appropriately determining that the main terminal 23a is not in use.

The above-described embodiments may be modified as follows. The above-described embodiments and the following modifications can be combined as long as the combined modifications remain technically consistent with each other.

In each embodiment, the sharing device 24 may be retrofitted to the vehicle 1 or installed in the vehicle 1 from the beginning.

In each embodiment, the sharing device 24 may be integrated with the verification ECU 9 to form a single unit.

In each embodiment, the sharing device 24 may be installed anywhere.

In each embodiment, the reservation of the vehicle 1 does not have to be performed with the main terminal 23a and may be performed with the further terminal 23b.

In each embodiment, the reservation of the vehicle 1 may be performed using only the further terminal 23b, not the main terminal 23a.

In each embodiment, the authentication performed by the portable terminal 23 and the sharing device 24 is not limited to authentication of the key information Dk and may be changed to another method.

P3P20190094US

In each embodiment, the granting of the operation privilege is not limited to assignment of the key information Dk to the counterpart and may be changed to another method such as providing a use permission command.

In each embodiment, the manual connection may be performed by a method other than performing a tapping operation on the screen of the portable terminal 23 such as moving the portable terminal 23 in a predetermined manner.

In each embodiment, the operation privilege may be granted to a user belonging to a different group.

In the second embodiment, the parameter detected is not limited to RSSI or acceleration and may be any characteristic value that indicates the positional change of the portable terminal 23.

In each embodiment, near-range wireless communication is not limited to Bluetooth® communication and may be changed to another communication protocol.

In each embodiment, the key information Dk is not limited to a one-time code and may be any information with limited usage.

In each embodiment, the content included in the key information Dk may be changed from that in the embodiment.

In each embodiment, the key information Dk does not have to be generated at the server 22 and may be generated at any external facility.

In each embodiment, the encryption code used for encrypted communication may be, for example, any of the unique sharing device encryption code, the user authentication code, and the unique electronic key encryption code. For example, switching encryption codes during the process will be further advantageous for improving the communication security. Further, the encryption code used is not limited to the above-mentioned codes and may be changed to various types of codes.

In each embodiment, the portable terminal 23 is not limited to a high-performance mobile phone and may be changed to various types of terminals.

In each embodiment, the portable terminal 23 and the sharing device 24 may obtain the user authentication code through any procedure or method.

In each embodiment, the key-function may be turned on under any condition.

In each embodiment, the connection control unit 41, the privilege granting unit 40, and the parameter detector 42 do not have to be functionally actuated by the user interface application 31 and may be actuated by other methods or formed by hardware elements.

In each embodiment, the operation-free electronic key system 4 is not limited to a system in which smart verification is performed by transmitters located inside and outside the vehicle determining whether the electronic key 2 is located inside or outside the vehicle. For example, the electronic key system 4 may be a system in which antennas (LF antennas) located on left and right sides of the vehicle body determine the location of the electronic key 2 inside and outside the vehicle by transmitting radio waves and checking the combination of responses from the electronic key 2.

In each embodiment, the ID verification required in the electronic key system 4 is not limited to the verification including a challenge-response authentication. Alternatively, the ID verification may include any authentication or verification that at least performs ID verification of an electronic key.

In each embodiment, the electronic key system 4 may be, for example, a wireless key system in which ID verification is performed when communication is established with the electronic key 2.

In each embodiment, the electronic key 2 is not limited to Smart Key® and may be a wireless key.

In each embodiment, the verification ECU 9 and sharing device 24 do not have to establish wireless communication and may be, for example, connected by wire. In this case, the sharing device 24 transmits various types of commands to the verification ECU 9 through wired communication. Even in this case, the verification ECU 9 can be actuated by instructions from the sharing device 24.

In each embodiment, the sharing device 24 does not have to use the electronic key system to operate the shared subject 19. In this case, the sharing device 24 directly transmits an instruction to a controller (CPU) that controls operations of the shared subject 19 to operate the shared subject 19. In this configuration, the key function of the sharing device 24 can be omitted.

In each embodiment, the sharing system 21 is not limited to be applied to the vehicle 1 and may be applied to other apparatus or device such as a residence (shared house), a shared delivery locker, or a coin-operated parking lot. Thus, the shared subject 19 is not limited to the vehicle 1 and may be changed to another member.

Technical concepts that can be understood from the above embodiments and the modified examples will now be described.

(A) When authentication is successful with a sharing device and a portable terminal, the sharing device performs smart verification through wireless communication network of an electronic key system. When the smart verification is successful, the sharing device permits or executes actuation of a shared subject with the portable terminal. In this configuration, the sharing device does not have to be wire-connected to an element of the electronic key system. This improves the degree of freedom for arrangement of the sharing device.

(B) A method for sharing a shared subject to enable operation of the shared subject with portable terminals including a main terminal and a further terminal. Each of the portable terminals is configured to operate the shared subject when the portable terminal obtains key information necessary to use the shared subject and the key information is authenticated through communication with the sharing device. The sharing method includes granting operation privilege of the sharing device from the main terminal to the further terminal and switching communication connection between the main terminal and the sharing device to manual connection when or after the operation privilege is granted to the further terminal.

1. A sharing system, comprising:
a sharing device arranged in a shared subject,
portable terminals including a main terminal and a further terminal, each obtaining key information required to use the shared subject and configured to operate the shared subject when authenticated through communication with the sharing device, and
a connection control unit configured to switch communication connection between the main terminal and the sharing device to manual connection when operation privilege is granted from the main terminal to the further terminal.

2. The sharing system according to claim 1, wherein
the operation privilege is the key information used for authentication performed with a corresponding one of the portable terminals and the sharing device, and
the key information is a one-time code that can be used only once or only within a fixed time period.

3. The sharing system according to claim 1 or 2, comprising:
an operation privilege granting unit that sets the further terminal in a group that is same as the main terminal and grants the operation privilege of the shared subject to the further terminal,
wherein the connection control unit is configured to switch communication connection between the main terminal and the sharing device to the manual connection when the operation privilege is granted to the further terminal in the same group as the main terminal.

4. The sharing system according to claim 1, wherein upon granting of the operation privilege from the main terminal to the further terminal, the connection control unit stops automatic connection that automatically connects the main terminal to the sharing device and switches communication connection between the main terminal and the sharing device to the manual connection.

5. The sharing system according to claim 1, comprising:
a parameter detector configured to detect a parameter that varies in accordance with a positional change of the main terminal,
wherein if operation privilege is granted from the main terminal to the further terminal when the connection control unit determines that a positional change of the main terminal is not occurring based on a detection signal of the parameter detector, the connection control unit forcibly interrupts connection between the main terminal and the sharing device and switches the communication connection to the manual connection.
